(19) United States
(12) Patent Application Publication
(10) Pub. No.: US 2020/0344975 A1
(43) Pub. Date: Nov. 5, 2020

(54) Pet Sling

(71) Applicant: LIGHTSPEED COMMERCE LLC, New York, NY (US)

(72) Inventor: Hyounggun Kwon, New York, NY (US)

(73) Assignee: LIGHTSPEED COMMERCE LLC, New York, NY (US)

(21) Appl. No.: 16/398,625

(22) Filed: Apr. 30, 2019

(51) Int. Cl. A01K 1/02; A01K 1/06

(52) U.S. Cl. CPC A01K 1/0254; A01K 1/06; A01K 1/029

(57) ABSTRACT

A pet sling provides a safe, comfortable and convenient way of carrying and transporting small to medium size pets. The pet sling is foldable, light weight and machine washable. It is also equipped with a safety collar hook to ensure the safety of the pet while carrying it. In addition, the length of the shoulder strap is adjustable. Pet owners can easily adjust the length of the shoulder strap according to their personal preferences.

### RELATED APPLICATION

This application is a continuation-in-part of U.S. Design patent application, filed Jul. 15, 2018, entitled “pet sling,” which is hereby incorporated by reference in its entirety.

### TECHNICAL FIELD

The present invention relates generally to a carrier for carrying and transporting pets, more specifically, to a foldable, hands-free carrier for carrying and transporting small to medium size pets.

### BACKGROUND

Small to medium pet owners enjoy the company of their pets. The pet owners often carry their pets during walks and hikes. While kennels, cages and pet carrier bags are frequently used to carry small pets, they can be inconvenient for the pet owners and uncomfortable for the pets being carried.

Most of pet carriers include a handle which engages the pet owner's hand and limits the movements of the pet owner. Some back-pack style pet carriers keep the pet out of the sight of the pet owner, which may be unsafe and could make the pet anxious.

In addition, most of current pet carriers are made of hard materials which is uncomfortable for pets to sit in for a long period of time. Furthermore, kennels, cages and pet carrier bags are usually heavy, hard to clean, and take a lot of space.

### SUMMARY OF INVENTION

A pet sling provides a safe, comfortable and convenient way of carrying and transporting small to medium size pets. The pet sling is ideal for carrying and transporting small to medium size dogs, such as the Maltese, Terriers and Chihuahua, and other pets such as cats and rabbits.

The pet sling employs a shoulder strap loops over the shoulder of the pet owner while the pet rests in the pouch on the opposite hip to keep the pet secure and comfortable. It frees the pet owner's hands and it does not significantly limit the pet owner's movement.

The pet sling is light weight and easy to use. Unlike kennels and cages, the pet sling add very little extra weight to the pet owner. Compare with the closed pet carriers, it is easy to place the pet in the open pouch and carry the pet sling.

The pet sling is made of soft fabric. The soil pet holding pouch can bend and hold the pet comfortably. Since it's made of soft fabric, the pet sling can be easily fold into small size and stored.

To ensure the safety of the pet and prevent it from jumping out of the pet sling, a safely collar hook is used to secure the pet to the pet sling.

A pocket is attached to the side of the shoulder strap, which is convenient to store small items such as keys, cards, cash, cellphone and pet treats.

The pet sling has adjustable shoulder strap. Pet owners can easily adjust the length of the shoulder strap according to their personal preferences.

In addition, the pet sling is made of fabrics that are suitable for machine washing.

### BRIEF DESCRIPTION OF THE DRAWINGS

FIG. 1 is a front view of a first embodiment of a pet sling;

FIG. 2 is a back view thereof;

FIG. 3 is a left view thereof;

FIG. 4 is a perspective view thereof;

FIG. 5 is a top view of the pet sling without rings and connectors, Which may connect two ends of the pet sling to each other;

FIG. 6 is a perspective view of the top sling without the rings and the connectors;

FIG. 7 is a perspective view of the rings and the connectors of the pet sling;

FIG. 8 is a front view of a second embodiment of a pet sling;

FIG. 9 is a back view thereof;

FIG. 10 is a left view thereof;

FIG. 11 is a perspective view thereof;

FIG. 12 is left view of the pet sling with rings and connectors, which may connect two ends of the pet sling to each other;

FIG. 13 is a perspective view of the top sling without the rings and the connectors;

FIG. 14 is a flowchart illustrating an example computer-implemented method for manufacturing a pet sling; and

FIG. 15 is a block diagram illustrating an example computer system for manufacturing a pet sling.

Embodiments of the present invention and their advantages are best understood by referring to the detailed description that follows. It should be appreciated that like reference numerals are used to identify like elements illustrated in one or more of the figures.

### DETAILED DESCRIPTION

The pet sling comprises one piece of fabric which is sewed and forms a pet carrying pouch and a shoulder strap, two O rings and a safety collar hook.

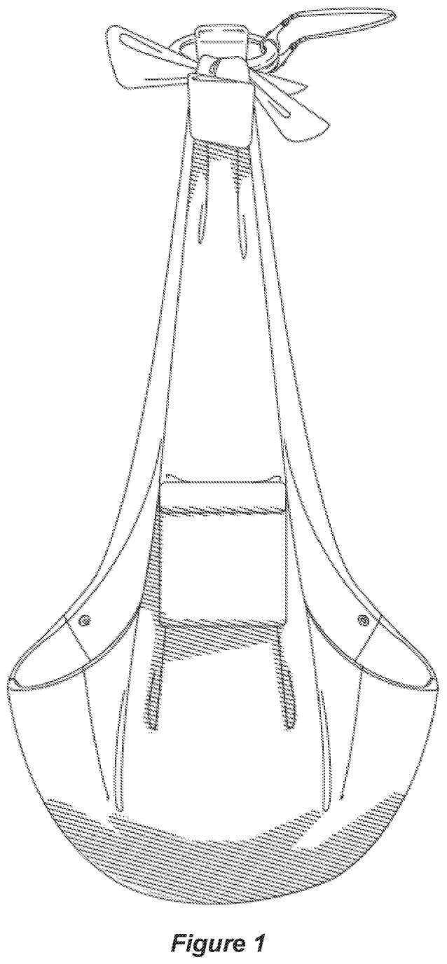

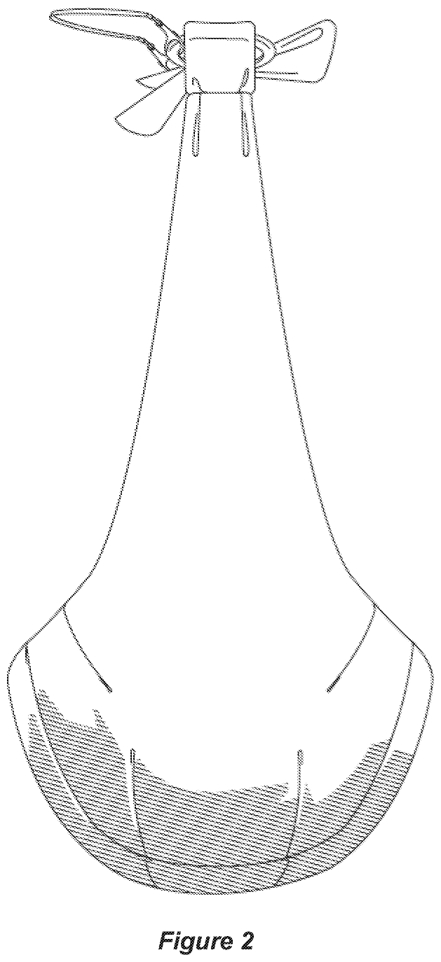

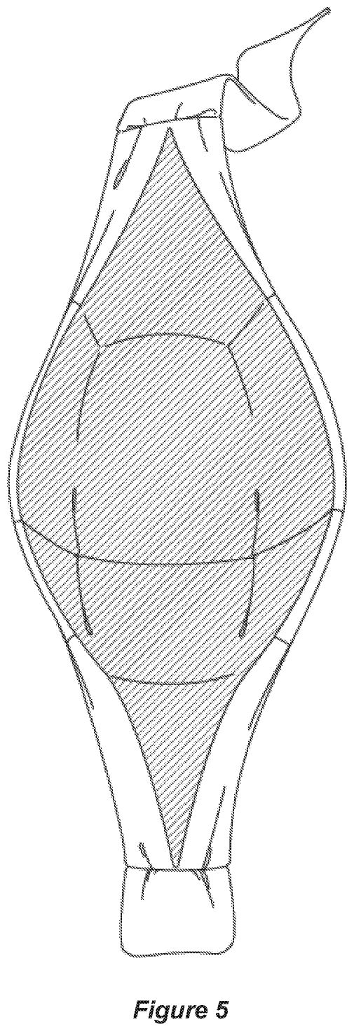

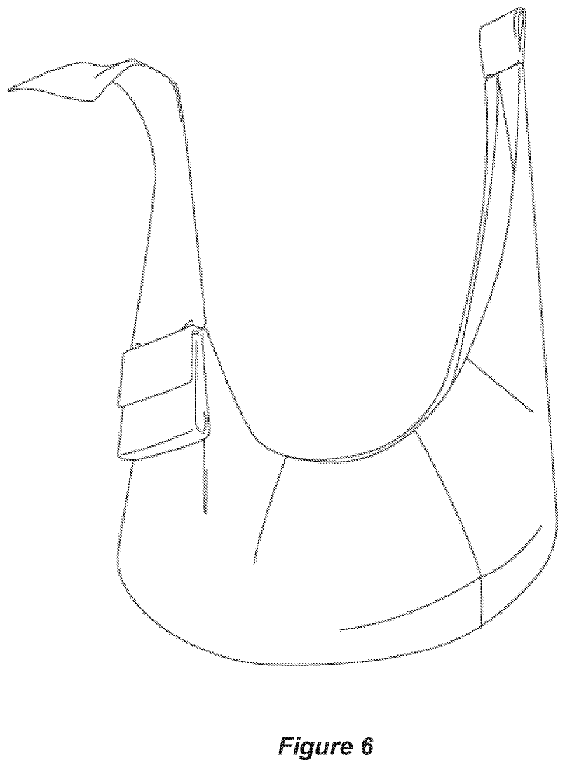

The piece of fabric is wide in the middle, and has two long thin strips on each end. As shown in FIGS. 1 to 6, various points of the wide middle part of the fabric is cut and sewed together to form a pouch which is used to carry pets.

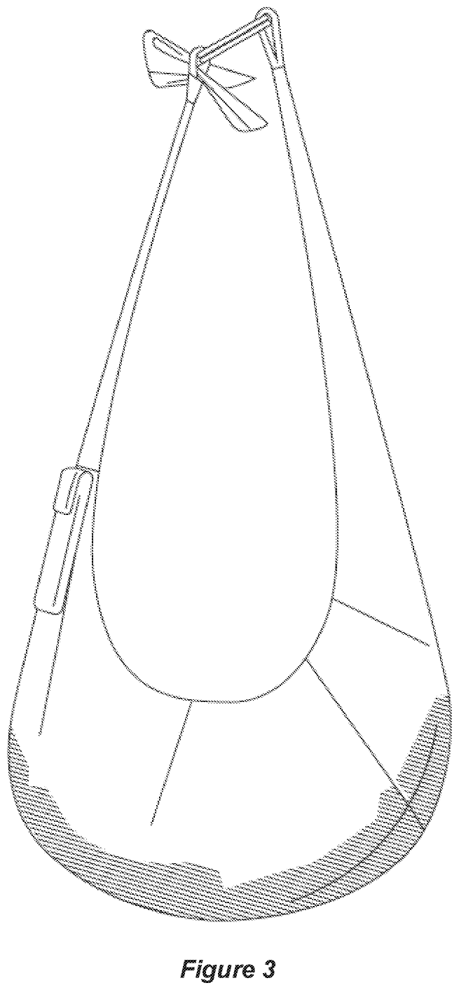

The two thin strips on each end are connected through the O rings to form a shoulder strap. The shoulder strap loops over the shoulder of the pet owner while the pet rests in the pouch on the opposite hip to keep the pet secure and comfortable. As shown in FIGS. 3 to 6, the tip of one thin strip is sewed into a loop. The tip of the other thin strip is not sewed, which leaves a loose end.

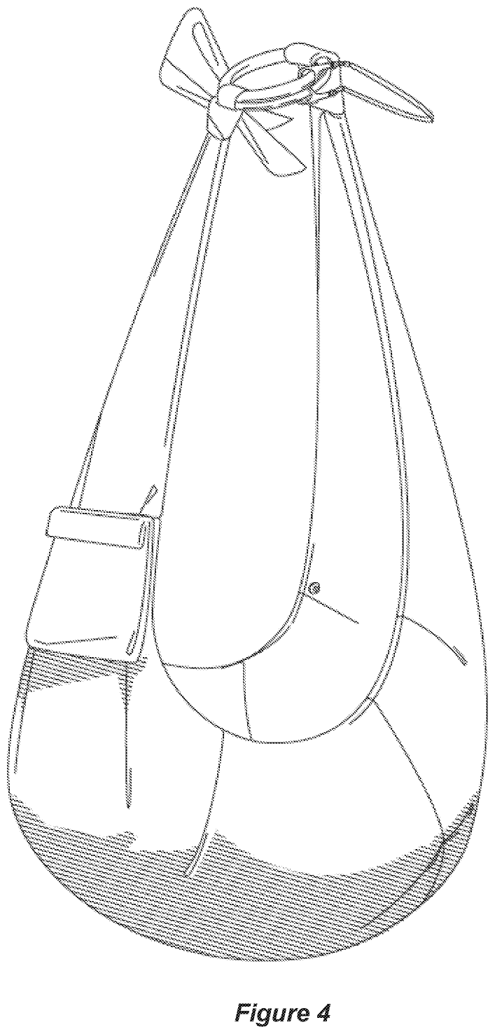

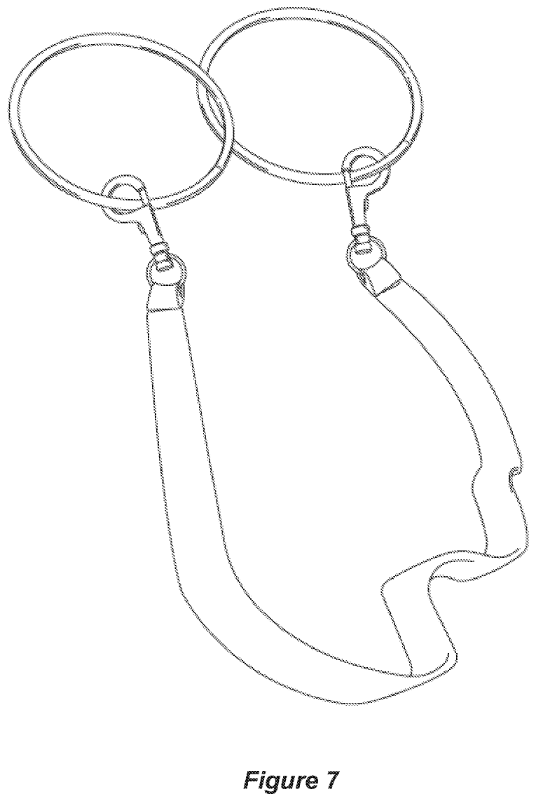

The O rings are made of material strong enough to carry the weight of a small to medium size pet. As shown in FIGS. 4 and 7, the O rings are not closed rings. The O rings are cut open, so they can hook to the loop end strip. Once the O rings are attached to the loop end strip, the loose end strip can be tied to the O rings to form the shoulder strap.

The length of the shoulder strap is adjustable. As shown in FIGS. 1 to 4, the loose end strip is tied to the O rings to form a shoulder strap. The length between the pouch and the O rings can be adjusted according to the pet owner's preference. The loose end strip is made of non-slippery material to enhance the strength of the knot tied through the O rings, which ensure the safely of the pet being carried.

As shown in FIGS. 1, 4, and 7, a safety collar hook is attached to the pet sling. The safety collar hook comprises two swivel snap hooks that are connected through a strong string. When the pet is being carried in the pet sling, to enhance the safety, one swivel snap hook is hooked to the O rings, and the other swivel snap hook is hooked to the pet vest or pet harness worn by the pet. The use of the safety collar hook will prevent the pet from jumping out of the pet sling. The safety collar hook will ensure that the pet is safely attached to the pet owner at all time.

As shown in FIGS. 1, 3, 4 and 6, a pocket is attached to the side of the shoulder strap, which is convenient to store small items such as keys, cards, cash, cellphone and pet treats.

When the pet sling is not being used, it can be quickly and easily folded. As shown in FIGS. 1 and 4, a few sets of snap-buttons are attached to each side of the pouch, which make it easy to close and fold the pouch by snapping the bottoms. Since the pet sling is made of soft fabrics, it can be further folded into smaller size. After being folded, the pet sling takes little space and can easily fit in handbags, back packs or clothes pockets.

The pet sling is made of fabric that is suitable for machine washing. After removing the O rings and the safety collar hook, the whole pet sling can be washed in a washing machine.

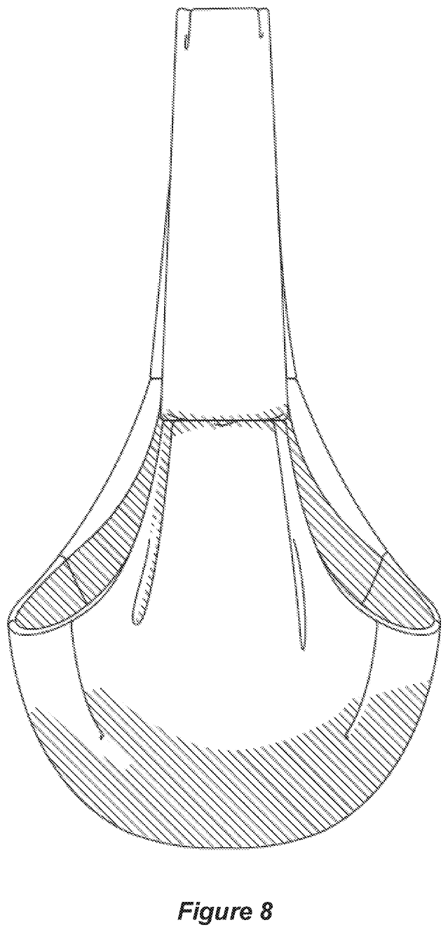

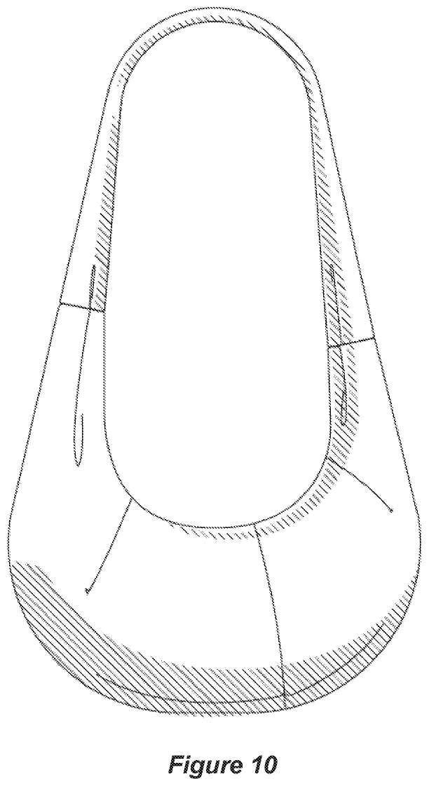

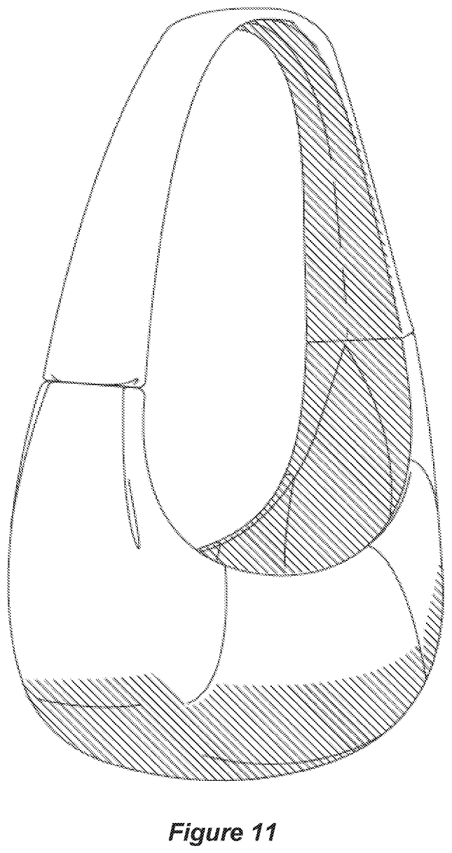

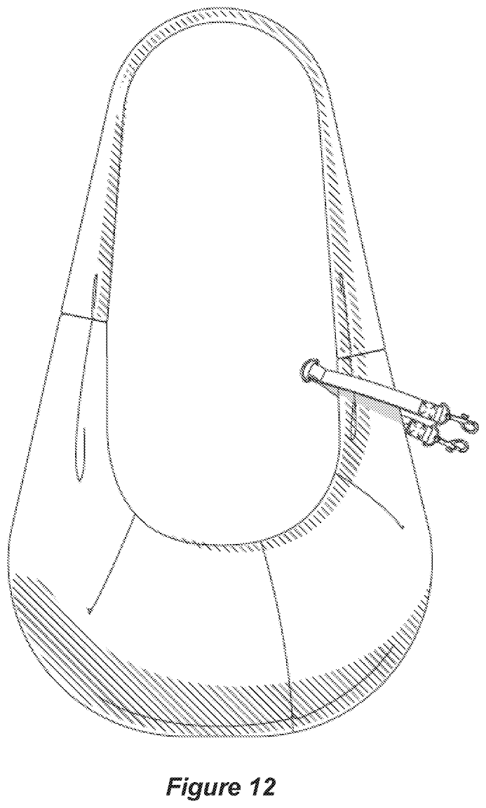

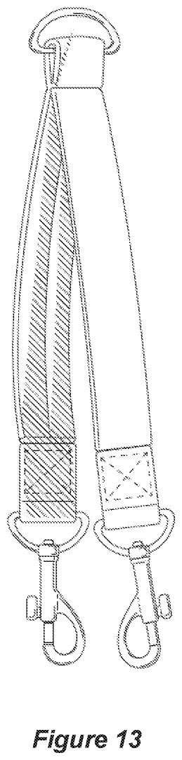

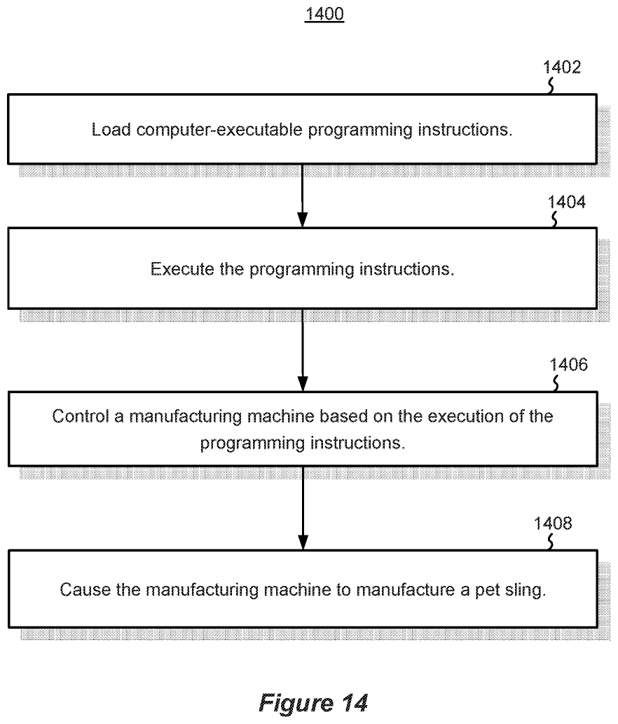

FIG. 14 is a flowchart illustrating an example computer-implemented method 600 for manufacturing a cable management tool. The computer-implemented method 1400 may be used to manufacture the pet slings shown with references to FIGS. 1-13. The computer system 1500, when properly programmed, can execute the method 1400.

In various implementations, the method 1400 includes using a computer to load (1402) computer-executable programming instructions from a non-volatile memory of the computer to a volatile memory of the computer. After loading the programming instructions, the computer may execute (1404) the programming instructions using the volatile memory.

Based on the execution of the programming instructions, the computer may control (1406) a manufacturing machine, for example, a cutting machine, a molding machine, or a pressing machine. By controlling the manufacturing machine, the computer causes (1.408) the manufacturing machine to manufacture a pet sling as described in one or more of the implementations disclosed in the present disclosure.

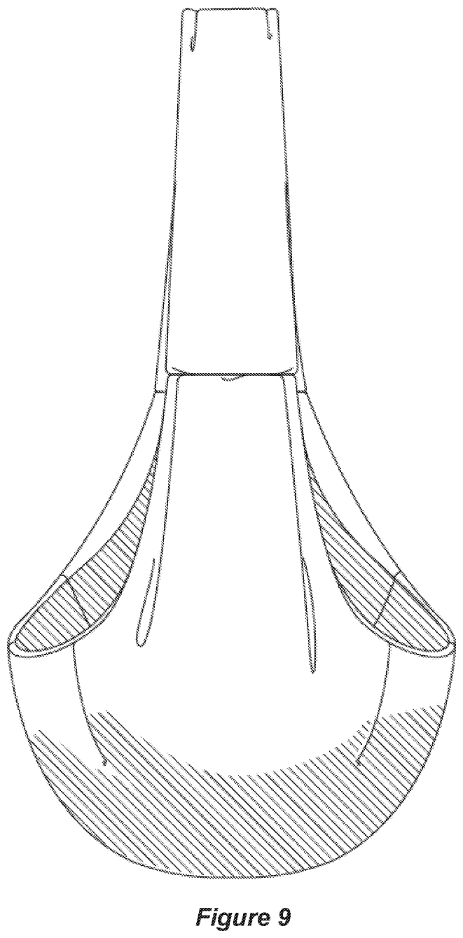

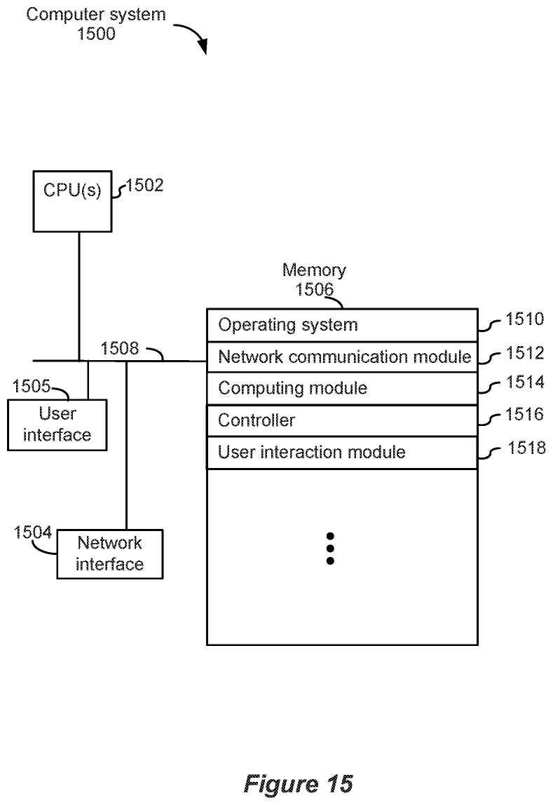

FIG. 15 is a block diagram illustrating an example computer system 1500 for manufacturing a pet sling. The computer system 1500 may be used to manufacture at least the cable management tools shown with references to FIGS. 1 and 9. The computer system 1500 in some implementations includes one or more processing units CPU(s) 1502 (also referred to as processors), one or more network interfaces, optionally a user interface, a memory 1506, and one or more communication buses 1510 for interconnecting these components. The communication buses 1510 optionally include circuitry (sometimes called a chipset) that interconnects and controls communications between system components. The memory 606 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 1506 optionally includes one or more storage devices remotely located from the CPU(s) 1502. The memory 1506, or alternatively the non-volatile memory device(s) within the memory 1506, comprises a non-transitory computer readable storage medium. In some implementations, the memory 1506 or alternatively the non-transitory computer readable storage medium stores the following programs, modules and data structures, or a subset thereof:
an operating system 1510 (e.g., an embedded Linux operating system), which includes procedures for handling various basic system services and for performing hardware dependent tasks;
a network communication module 1512 for connecting the computer system with a manufacturing machine via one or more network interfaces (wired or wireless);
a computing module 1514 for executing programming instructions;
a controller 1516 for controlling a manufacturing machine in accordance with the execution of programming instructions; and
a user interaction module 1518 for enabling a user to interact with the computer system 1500.

One or more of the above identified elements may be stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory optionally stores a subset of the modules and data structures identified above. Furthermore, the memory may store additional modules and data structures not described above.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first connector could be termed a second connector, and, similarly, a second connector could be termed a first connector, without changing the meaning of the description, so long as all occurrences of the “first connector” are renamed consistently and all occurrences of the “second connector” are renamed consistently. The first connector and the second connector are both connectors, but they are not the same connector.

The terminology used herein is for the purpose of describing particular implementations only and is not intended to be limiting of the claims. As used in the description of the implementations and the appended claims, the singular forms “a”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

What is claimed is:

1. A pet sling, comprising:
a pet carry pouch sewed using a single piece of flexible stretch resistant material, wherein the sling has opposed front and rear longer sides extending around two lateral; wherein
the flexible stretch resistant material is resistant to stretching and deformation in at least a direction that extends around the two lateral sides;
a length-adjustable shoulder strap having both ends connected to the pet carry pouch;
two rings configured to form a loop including the length-adjustable shoulder strap and the pet carry pouch; and
a safety collar hook.

2. The pet sling of claim 1, wherein the safety collar hook includes a first connector and a second connector, wherein the first connector connects to a ring in the two rings, and the second connector indirectly connects to a pet.

3. The pet sling of claim 1, further comprising: a plurality of snap buttons for folding the pet carry pouch into a smaller size.

4. The pet sling of claim 1, further comprising: a plurality of snap buttons for folding the pet carry pouch into a smaller size.

5. The pet sling of claim 1, wherein one end of the length-adjustable shoulder strap is close-ended, and the other end of the length-adjustable shoulder strap is open-ended.

6. The pet sling of claim 5, wherein the open-ended end of the length-adjustable shoulder strap is configured to form a bow-tie shape on one of the two rights.

7. The pet sling of claim 1, wherein the two rings are O-shape rings.

8. The pet sling of claim 7, wherein at least one ring of the two O-shape rings includes one or more openings.

9. The pet sling of claim 1, wherein the flexible stretch resistant material is machine washable.

10. The pet sling of claim 1, further comprising: a pocket configured to storage one or more personal items.

11. The pet sling of claim 10, wherein the pocket includes a flap.

12. A method for manufacturing the pet sling of claim 1.

13. A non-transitory computer readable storage medium, comprising: computer executable instructions stored thereon, which, when executed by one or more computers, cause a machine to manufacture the pet sling of claim 1.
